(19) United States
(12) Patent Application Publication
(10) Pub. No.: US 2009/0207415 A1
(43) Pub. Date: Aug. 20, 2009

(54) METHOD OF READING INFORMATION FROM A HOLOGRAPHIC DATA STORAGE MEDIUM AND HOLOGRAPHIC DATA READ OUT DEVICE

(75) Inventor: Frank Jeroen Pieter Schuurmans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/278,987

(22) PCT Filed: Feb. 12, 2007
(86) PCT No.: PCT/IB07/50453

§ 371 Date: Aug. 11, 2008

(30) Foreign Application Priority Data
Feb. 14, 2006 (EP) 06300132.5

(51) Int. Cl. G01B 9/021

(52) U.S. Cl. 356/457

(57) ABSTRACT

The present invention relates to a method of reading information from a holographic data storage medium (10), comprising the steps of: projecting a reference beam (12) having defined properties of a first type into the holographic data storage medium, thereby generating a first diffracted beam (14), detecting the first diffracted beam by a detector array (16) having a plurality of detector areas, selecting a first set of detector areas useful for reconstructing information stored in the holographic data storage medium, reading out data from the first set of detector areas, and not reading out data from other detector areas, projecting a reference beam having defined properties of a second type different from the first type into the holographic data storage medium, thereby generating a second diffracted beam, detecting the second diffracted beam by the detector array having a plurality of detector areas, and selecting a second set of detector areas useful for reconstructing information stored in the holographic data storage medium, reading out data from the second set of detector areas, and not reading out data from other detector areas, the second set of detector areas being different from the first set of detector areas. The present invention further relates to a holographic data read out device.

### FIELD OF THE INVENTION

The present invention relates to a method of reading information from a holographic data storage medium and to a holographic data read out device.

### BACKGROUND OF THE INVENTION

In holographic data storage data is usually read out from the holographic medium by illuminating it with the exact same reference beam that was used to write the data. This means that the beam has the same properties as the writing beam, particularly concerning its wavelength and its incident angle on the holographic medium. The reference beam is then diffracted off the three-dimensional refractive index modulation in the medium. The coherent diffracted light originates from all locations in the volume of the medium and ultimately interferes at the detector array, constructing the original intensity image that was used on the spatial light modulator for writing the data. For the successful reconstruction of the data page on the detector array, all the phases of the diffracted light wavelets should be matched. This requires illumination with the exact same reference beam. Further, temperature variation results in deformation of the medium which leads to phase mismatches on the detector array and loss in read out fidelity. Therefore, tight tolerances on temperature variation are required.

Recently, Toishi et al. (refer to: Temperature tolerance improvement with wavelength tuning laser source in holographic data storage, M. Toishi, T. Tanaka, M. Sugiki, K. Watanabe, Tech. Digest ISOM/ODS 05) showed a method that allows for higher temperature tolerance in holographic data storage by using angle and/or wavelength tuning of the reference beam. For temperature differences between the writing phase and the read out phase, data can be retrieved from the medium by changing the incident angle and/or the wavelength of the reference beam in read out phase with respect to the situation in the writing phase. For high temperature differences, larger than about 10 degrees Celsius, the data page is only partially reconstructed. The part that is reconstructed depends on the incident angle and/or wavelength of the reference beam. Correspondingly, the full data page is read out sequentially in time by illuminating the medium sequentially with the appropriate reference beam with varying incident angle and/or wavelength, so that for this series of illumination the partial data pages form the full data page. For example, a full data page can be reconstructed from three partial data pages measured for three different wavelengths, in case that for each illumination roughly ⅓ of the data page is reconstructed.

A problem of this useful partial reconstruction concept is related to the read data rate. In order to reconstruct one data page, more than once the detector array has to be read out.

It is therefore an object of the invention to provide a method of reading information from a holographic data storage medium and a holographic read out device providing an improved read data rate when the concept of partial reconstruction is employed.

### SUMMARY OF THE INVENTION

The above objects are solved by the features of the independent claims. Further developments and preferred embodiments of the invention are outlined in the dependent claims.

In accordance with the invention, there is provided a method of reading information from a holographic data storage medium, comprising the steps of:

projecting a reference beam having defined properties of a first type into the holographic data storage medium, thereby generating a first diffracted beam,

detecting the first diffracted beam by a detector array having a plurality of detector areas,

selecting a first set of detector areas useful for reconstructing information stored in the holographic data storage medium, reading out data from the first set of detector areas, and not reading out data from other detector areas,

projecting a reference beam having defined properties of a second type different from the first type into the holographic data storage medium, thereby generating a second diffracted beam,

detecting the second diffracted beam by the detector array having a plurality of detector areas, and

selecting a second set of detector areas useful for reconstructing information stored in the holographic data storage medium, reading out data from the second set of detector areas, and not reading out data from other detector areas, the second set of detector areas being different from the first set of detector areas.

In case that the holographic data storage medium is deformed during the read out phase in comparison to the write phase, a loss in read out fidelity is observed. This can be compensated by providing a reference beam having particular properties that are different from the properties of the write beam. Since the properties of the reference beam have influence on the light path, only a part of the detector array will receive a diffracted beam carrying useful information. By changing the properties of the reference beam from the first type to a second type, a different part of the detector will receive useful information. By reading out only those areas of the detector array that receive these useful information the read out time can be considerably reduced as compared to the case when the whole detector array is read out for each type of reference beam.

Particularly, the properties of the reference beam to be varied comprise the wavelength of the projected light. Variation of the wavelength is one possibility to change the properties of the reference beam in order to compensate for deformation of the holographic data storage medium, particularly due to temperature effects.

As another additional or alternative concept, the properties of the reference beam to be varied comprise the angle by which the beam is incident on the holographic data storage medium.

According to a preferred embodiment of the present invention, the steps of selecting a set of detector areas consider a temperature measured around the holographic data storage medium. The temperature should be measured in a position usually having a temperature that is related to the temperature of the holographic data storage medium, e. g. in the disc drive near the position of the storage medium. The temperature information can be used for deciding, whether the reference beam properties have to be changed at all during read out, and, if yes, in which way. From the beam properties selected, particularly wavelength and incident angle, it can be concluded which part of the detector is to be read out.

Preferably, a CMOS detector is used as the detector array which is read out by windowing. In CMOS active-pixel image sensors, both the photodetector and the read out amplifier are part of each pixel. This allows the integrated charge to be converted into a voltage inside the pixel, which can then be read out over X-Y wires (instead of using a charge domain shift register, as in CCDs). This column and row addressability, similar to common DRAM, allows for window-of-interest readout (windowing), as for example known from image processing in digital cameras.

In accordance with a further aspect of the invention, there is provided a holographic data read out device comprising:

means for projecting a reference beam having defined properties into a holographic data storage medium, thereby generating a diffracted beam,

a detector array having a plurality of detector areas for detecting a diffracted beam, and

means for selecting a set of detector areas useful for reconstructing information stored in the holographic data storage medium, reading out data from the selected set of detector areas, and not reading out data from other detector areas.

Preferably, a temperature sensor for determining a temperature around the holographic data storage medium is provided.

According to a particularly advantageous embodiment, the detector array is formed by a CMOS detector.

These and other aspects of the invention will be apparent from and elucidated with reference to the embodiments described hereinafter.

### BRIEF DESCRIPTION OF THE DRAWINGS

FIG. 1 shows a schematic set up for illustrating the present invention.

FIG. 2 shows a flow diagram for illustrating a method in accordance with the present invention.

### DESCRIPTION OF PREFERRED EMBODIMENTS

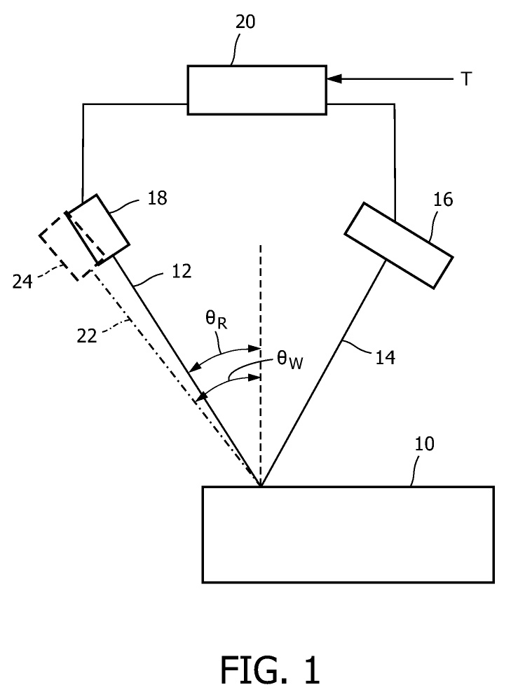

FIG. 1 shows a schematic set up for illustrating the present invention. A holographic data storage medium 10 comprises information stored therein that is to be read out by a reference beam 12 projected on the holographic data storage medium 10. The means 18 are projecting the reference beam 12 with an incident angle θ_{R} different from the incident angle 0_{W} by which the writing beam 22 was projected by the writing means 24. The difference between the writing angle θ_{W} and the reading angle θ_{R} is chosen in order to compensate for a deformation of the holographic data storage medium 10 that is most probably induced by temperature effects. The reference beam 12 results in a diffracted beam 14 that is received by a detector 16. In this example the reference beam is diffracted and reflected, however it may also be diffracted and transmitted by the holographic data storage medium 10. The detector 16 is preferably a CMOS detector having a plurality of individually addressable detector areas. Control means 20 are provided that are able to read out a particular set of detector areas. These detector areas are selected in dependence on the incident angle θ_{R} of the reference beam 12 that is chosen under consideration of the temperature T around the holographic data storage medium. If, for example, the temperature T considerably differs from the temperature during writing to the holographic data storage medium, the angle θ_{R} is chosen to be different from the angle θ_{W}, and the control means 20 only reads out those detector areas that obtain useful information. In a next step, the angle θ_{R} is changed, and a different set of detector areas is read out by the control means 20, etc.

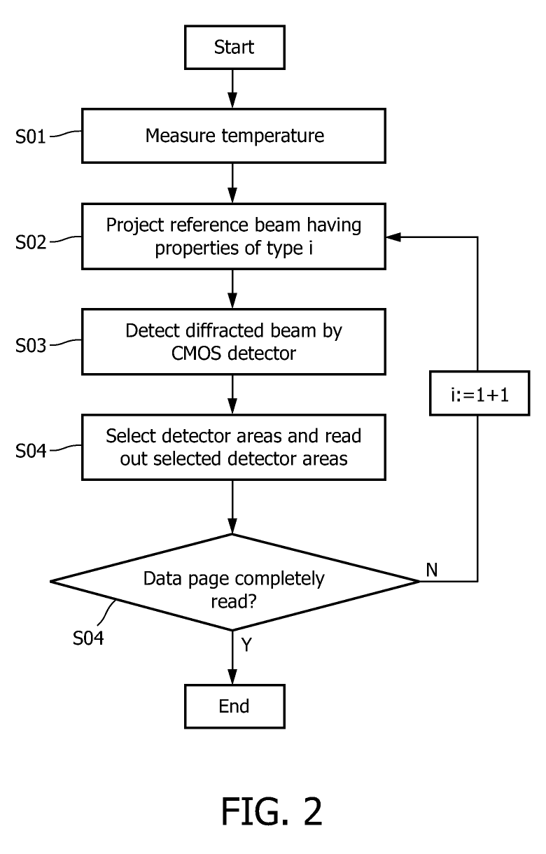

FIG. 2 shows a flow diagram for illustrating a method in accordance with the present invention. A typical flow of steps for reading a data page from a holographic data medium is shown. After start the temperature around the holographic data storage medium is measured (S01) then, in step S02 a reference beam is projected on the holographic data storage medium; the reference beam has particular properties of type i. The type stands specifically for the wavelength and the incident angle of the reference beam. In step S03 the diffracted beam is detected by the CMOS detector. In step S04 detector areas are selected that obtain useful information, and these selected detector areas are read out. In step S05 it is decided whether the whole data page has already been completely read. If so, the flow for reading a data page ends. If not, the flow continues in step S02 by projecting a reference beam having a different property than before.

Summarizing, it is proposed to use temperature feed forward on the windowing of a CMOS detector array, ensuring that only the part of the detector array is read out that indeed images the area of the data page that is reconstructed. The advantage is that only the useful part of the detector array is read out without wasting read data rate on the parts of the detector array that do not carry any information, for a particular angle and/or wavelength setting of the reference beam. This results in minimal slowing down of the read data rate as compared to read out without deformation compensation. It is particularly advantageous to use a reading from a temperature sensor that determines the temperature of the drive, and thus the medium, and to use this information to predetermine which area on the detector array will receive the partially reconstructed data page. Using this feed forward scheme, only the appropriate area on the detector array needs to be read out. CMOS detectors are very well suited for this as they allow so-called windowing, i.e. read out of a fraction of the total area of the sensor.

Equivalents and modifications not described above may also be employed without departing from the scope of the invention, which is defined in the accompanying claims.

1. A method of reading information from a holographic data storage medium (10), comprising the steps of:
projecting a reference beam (12) having defined properties of a first type into the holographic data storage medium, thereby generating a first diffracted beam (14),
detecting the first diffracted beam by a detector array (16) having a plurality of detector areas,
selecting a first set of detector areas useful for reconstructing information stored in the holographic data storage medium, reading out data from the first set of detector areas, and not reading out data from other detector areas,
projecting a reference beam having defined properties of a second type different from the first type into the holographic data storage medium, thereby generating a second diffracted beam,
detecting the second diffracted beam by the detector array having a plurality of detector areas, and
selecting a second set of detector areas useful for reconstructing information stored in the holographic data storage medium, reading out data from the second set of detector areas, and not reading out data from other detector areas, the second set of detector areas being different from the first set of detector areas.

2. The method according to claim 1, wherein the properties of the reference beam (12) to be varied comprise the wavelength of the projected light.

3. The method according to claim 1, wherein the properties of the reference beam (12) to be varied comprise the angle by which the beam is incident on the holographic data storage medium (10).

4. The method according to claim 1, wherein the steps of selecting a set of detector areas consider a temperature measured around the holographic data storage medium (10).

5. The method according to claim 1, wherein a CMOS detector (16) is used as the detector array which is read out by windowing.

6. A holographic data read out device comprising:
means (18) for projecting a reference beam (12) having defined properties into a holographic data storage medium (10), thereby generating a diffracted beam,
a detector array (16) having a plurality of detector areas for detecting a diffracted beam (14), and
means (20) for selecting a set of detector areas useful for reconstructing information stored in the holographic data storage medium, reading out data from the selected set of detector areas, and not reading out data from other detector areas.

7. The holographic data read out device according to claim 6, wherein a temperature sensor (T) for determining a temperature around the holographic data storage medium is provided.

8. The holographic data read out device according to 6, wherein the detector array is formed by a CMOS detector (16).
